(19) United States
(12) Patent Application Publication
(10) Pub. No.: US 2014/0241180 A1
(43) Pub. Date: Aug. 28, 2014

(54) EVOLVED MULTIMEDIA BROADCAST MULTICAST SERVICE (eMBMS) INTER-FREQUENCY CELL RESELECTION

(71) Applicant: QUALCOMM INCORPORATED, San Diego, CA (US)

(72) Inventors: Daniel Amerga, San Diego, CA (US); Udayan Murli Bhawnani, San Diego, CA (US); Kuo-Chun Lee, San Diego, CA (US); Shailesh Maheshwari, San Diego, CA (US); Muhammad Arif Munif, San Diego, CA (US); Ketan Narendra Patel, Santa Clara, CA (US); Jack S. Shauh, San Diego, CA (US); Hashim Shaik, San Diego, CA (US); Sivaramakrishna Veerapalli, San Diego, CA (US)

(73) Assignee: Qualcomm Incorporated, San Diego, CA (US)

(21) Appl. No.: 13/777,030

(22) Filed: Feb. 26, 2013

(51) Int. Cl. H04W 36/30

(52) U.S. Cl. CPC H04W 36/30
USPC 370/252

(57) ABSTRACT

A method for inter-frequency cell reselection by a wireless communication device is described. The wireless communication device camps on a serving cell. An evolved multimedia broadcast multicast service (eMBMS) service provided by a neighbor cell is discovered. Inter-frequency parameters of the neighbor cell are measured. It is determined whether to perform an inter-frequency cell reselection based on one or more inter-frequency cell reselection factors. An inter-frequency cell reselection to the neighbor cell is performed.

### TECHNICAL FIELD

The present disclosure relates generally to wireless communication systems. More specifically, the present disclosure relates to systems and methods for evolved Multimedia Broadcast Multicast Service (eMBMS) inter-frequency cell reselection.

### BACKGROUND

Wireless communication systems are widely deployed to provide various types of communication content such as voice, video, data and so on. These systems may be multiple-access systems capable of supporting simultaneous communication of multiple wireless communication devices with one or more base stations.

Sometimes a wireless communication device will switch from monitoring one cell on a first frequency (via a first base station) to monitoring another cell on a second frequency (via a second base station) when the wireless communication device has already registered with the first base station and is camped on the first base station. This may be referred to as inter-frequency cell reselection. The introduction of new technologies requires improvements to inter-frequency cell reselection procedures. Benefits may be realized by improvements to inter-frequency cell reselection procedures for Multimedia Broadcast Multicast Service (MBMS).

### BRIEF DESCRIPTION OF THE DRAWINGS

FIG. 1 shows a wireless communication system;

FIG. 2 illustrates a Multimedia Broadcast over a Single Frequency Network (MBSFN) infrastructure;

FIG. 3 illustrates the channel structure for a Multimedia Broadcast over a Single Frequency Network (MBSFN) area;

FIG. 4 illustrates one configuration of the format for a Multicast Channel Scheduling Information (MSI) Media Access Control (MAC) control element;

FIG. 5 is a block diagram illustrating an evolved Multicast Broadcast Multimedia Service (eMBMS) inter-frequency cell reselection module;

FIG. 6 is a flow diagram of a method for evolved Multicast Broadcast Multimedia Service (eMBMS) inter-frequency cell reselection;

FIG. 7 is a flow diagram illustrating a detailed configuration of a method for evolved Multicast Broadcast Multimedia Service (eMBMS) inter-frequency cell reselection;

FIG. 8 is a flow diagram illustrating another detailed configuration of a method for evolved Multicast Broadcast Multimedia Service (eMBMS) inter-frequency cell reselection;

FIG. 9 is a flow diagram illustrating yet another detailed configuration of a method for evolved Multicast Broadcast Multimedia Service (eMBMS) inter-frequency cell reselection;

FIG. 10 is a flow diagram illustrating another detailed configuration of a method for evolved Multicast Broadcast Multimedia Service (eMBMS) inter-frequency cell reselection;

FIG. 11 is a thread diagram illustrating one example of evolved Multicast Broadcast Multimedia Service (eMBMS) inter-frequency cell reselection; and

FIG. 12 illustrates certain components that may be included within a wireless communication device.

### DETAILED DESCRIPTION

A wireless communication device may camp on a serving cell. The wireless communication device may discover an evolved Multicast Broadcast Multimedia Service (eMBMS) service provided by a neighbor cell. The wireless communication device may measure inter-frequency parameters of the neighbor cell. By determining whether to perform an inter-frequency cell reselection based on one or more inter-frequency cell reselection factors, the wireless communication device may reduce the delay to establish an evolved Multicast Broadcast Multimedia Service (eMBMS) service on the neighbor frequency when the wireless communication device is in idle mode.

In the following description, for reasons of conciseness and clarity, terminology associated with the Long Term Evolution (LTE) standards, as promulgated under the 3rd Generation Partnership Project (3GPP) by the International Telecommunication Union (ITU), is used. It should be noted that the invention is also applicable to other technologies, such as technologies and the associated standards related to Code Division Multiple Access (CDMA), Time Division Multiple Access (TDMA), Frequency Division Multiple Access (FDMA), Orthogonal Frequency Division Multiple Access (OFDMA) and so forth. Terminologies associated with different technologies can vary. For example, depending on the technology considered, a wireless device can sometimes be called a user equipment, a mobile station, a mobile terminal, a subscriber unit, an access terminal, etc., to name just a few. Likewise, a base station can sometimes be called an access point, a Node B, an evolved Node B, and so forth. It should be noted that different terminologies apply to different technologies when applicable.

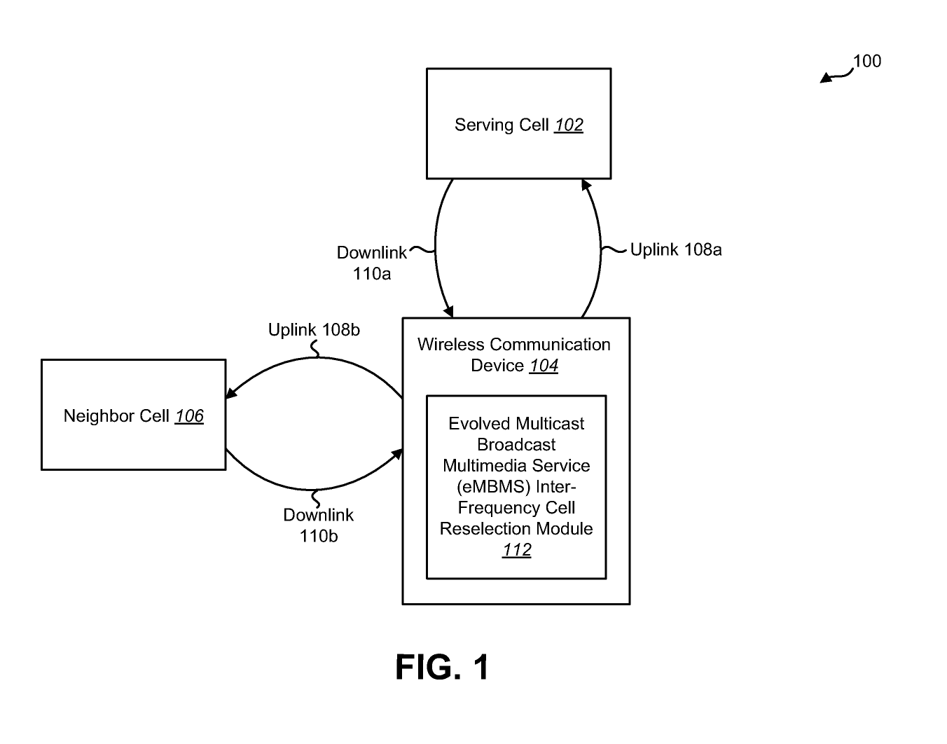

FIG. 1 shows a wireless communication system 100. Wireless communication systems 100 are widely deployed to provide various types of communication content such as voice, data and so on. A wireless communication system 100 may include multiple wireless devices. A wireless device may be a base station or a wireless communication device 104. A wireless communication device 104 may be configured to perform fast inter-frequency cell reselection procedures based on one or more inter-frequency cell reselection factors, which may include reducing a Treselection time or reducing a blocking period.

A base station is a station that communicates with one or more wireless communication devices 104. A base station may also be referred to as, and may include some or all of the functionality of, an access point, a broadcast transmitter, a NodeB, an evolved NodeB, etc. The term “base station” will be used herein. Each base station provides communication coverage for a particular geographic area. A base station may provide communication coverage for one or more wireless communication devices 104. The term “cell” can refer to a base station and/or its coverage area, depending on the context in which the term is used. The wireless communication system 100 may include a serving cell 102 and at least one neighbor cell 106. The serving cell 102 may include one or more base stations. Each neighbor cell 106 may also include one or more base stations.

Communications in a wireless system (e.g., a multiple-access system) may be achieved through transmissions over a wireless link. Such a communication link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink and downlink transmissions are in the same frequency region so that the reciprocity principle allows the estimation of the downlink channel from the uplink channel. This enables a transmitting wireless device to extract transmit beamforming gain from communications received by the transmitting wireless device.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, single-carrier frequency division multiple access (SC-FDMA) systems, 3^{rd} Generation Partnership Project (3GPP) Long Term Evolution (LTE) systems and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and Long Term Evolution (LTE) are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems and mobile devices.

In 3GPP Long Term Evolution (LTE), a wireless communication device 104 may be referred to as a “user equipment” (UE). A wireless communication device 104 may also be referred to as, and may include some or all of the functionality of, a terminal, an access terminal, a subscriber unit, a station, etc. A wireless communication device 104 may be a cellular phone, a personal digital assistant (PDA), a wireless device, a wireless modem, a handheld device, a laptop computer, etc.

A wireless communication device 104 may communicate with zero, one or multiple base stations on the downlink 110a-b and/or uplink 108a-b at any given moment. The downlink 110 (or forward link) refers to the communication link from a cell (via a base station) to a wireless communication device 104, and the uplink 108 (or reverse link) refers to the communication link from a wireless communication device 104 to a cell (via a base station).

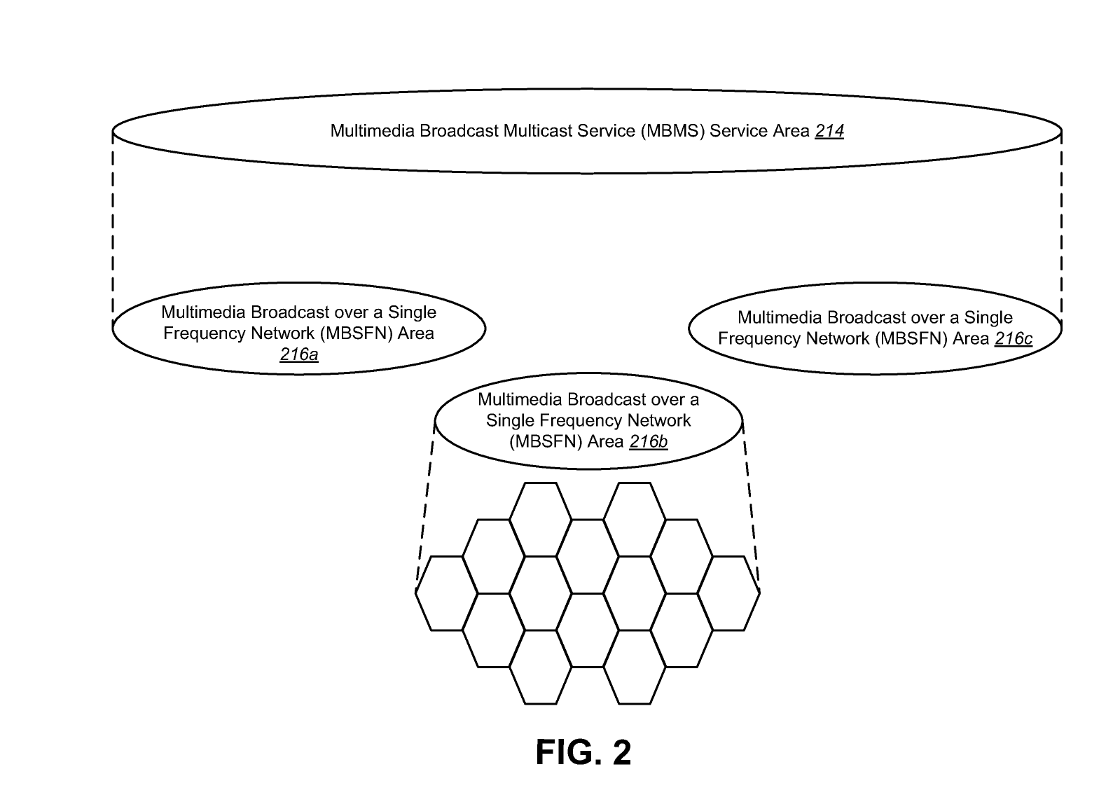

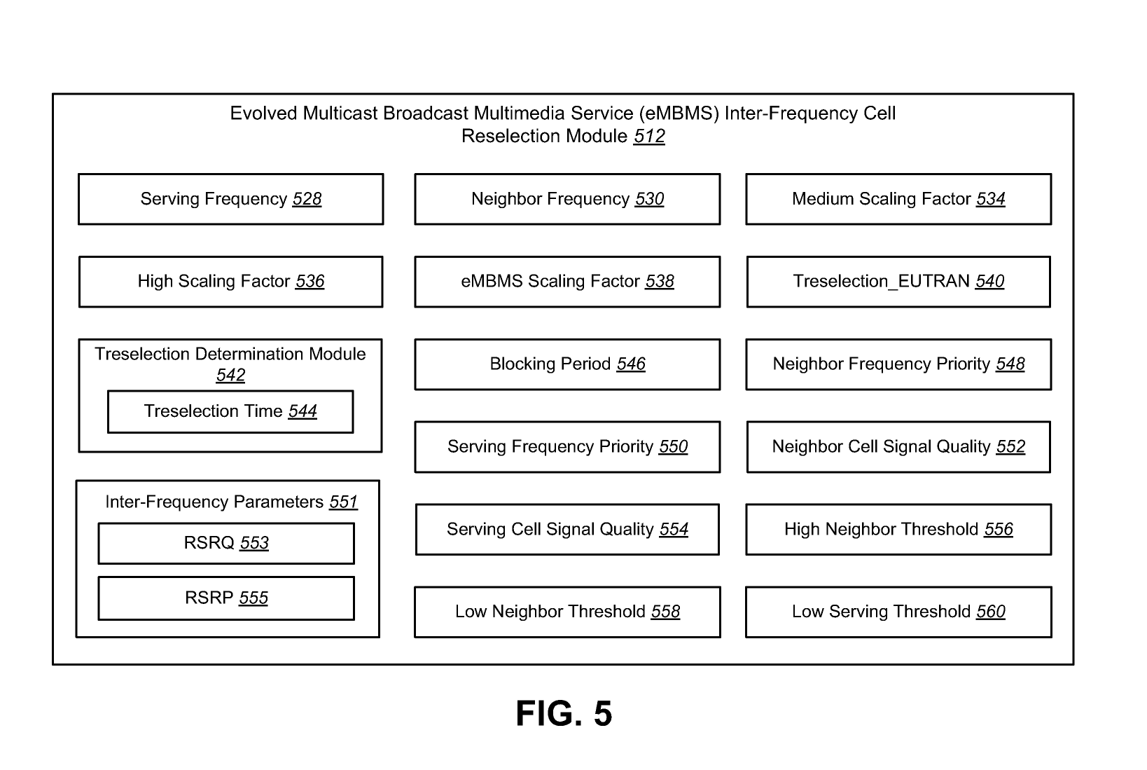

Long Term Evolution (LTE) Release 9 provides support for evolved Multicast Broadcast Multimedia Service (eMBMS) in the Long Term Evolution (LTE) air interface using the Multimedia Broadcast over a Single Frequency Network (MBSFN) infrastructure. The Multimedia Broadcast over a Single Frequency Network (MBSFN) infrastructure is discussed in additional detail below in relation to FIG. 2. The wireless communication device 104 may include an evolved Multicast Broadcast Multimedia Service (eMBMS) inter-frequency cell reselection module 112 that allows the wireless communication device 104 to perform inter-frequency cell reselection procedures in the Multimedia Broadcast over a Single Frequency Network (MBSFN) infrastructure. The evolved Multicast Broadcast Multimedia Service (eMBMS) inter-frequency cell reselection module 112 performs inter-frequency cell reselection procedures based on one or more inter-frequency cell reselection factors. The evolved Multicast Broadcast Multimedia Service (eMBMS) inter-frequency cell reselection module 112 is discussed in additional detail below in relation to FIG. 5.

The wireless communication device 104 may need to perform inter-frequency cell reselection to reselect from the serving cell 102 to a neighbor cell 106 when the wireless communication device 104 is in idle mode. For example, the wireless communication device 104 may discover an evolved Multicast Broadcast Multimedia Service (eMBMS) service that is provided by the neighbor cell 106. However, before the wireless communication device 104 reselects from the serving cell 102 to the neighbor cell 106, the wireless communication device 104 may determine whether inter-frequency cell reselection conditions are met. The inter-frequency cell reselection conditions may include determining whether the wireless communication device 104 has been camped on the serving cell 102 for a certain amount of time (referred to as a blocking period). The inter-frequency cell reselection conditions may also include determining whether the neighbor cell 106 signal quality is greater than a threshold value for a predetermined amount of time (referred to as a Treselection time).

However, using the blocking period and the Treselection time may result in an undesirable delay in establishing the evolved Multicast Broadcast Multimedia Service (eMBMS) service on the neighbor cell 106. For example, a wireless communication device 104 may need eight or more seconds before the evolved Multicast Broadcast Multimedia Service (eMBMS) service is established. The evolved Multicast Broadcast Multimedia Service (eMBMS) inter-frequency cell reselection module 112 allows the wireless communication device 104 to improve the latency for obtaining evolved Multicast Broadcast Multimedia Service (eMBMS) on the neighbor cell 106. For example, the evolved Multicast Broadcast Multimedia Service (eMBMS) inter-frequency cell reselection module 112 may determine whether to perform inter-frequency cell reselection based on one or more inter-frequency cell reselection factors. The inter-frequency cell reselection factors may reduce or eliminate the blocking period and/or the Treselection time, resulting in faster evolved Multicast Broadcast Multimedia Service (eMBMS) inter-frequency cell reselection.

FIG. 2 illustrates a Multimedia Broadcast over a Single Frequency Network (MBSFN) infrastructure. The Multimedia Broadcast over a Single Frequency Network (MBSFN) infrastructure may include a Multimedia Broadcast Multicast Service (MBMS) service area 214, which is the area with evolved Multicast Broadcast Multimedia Service (eMBMS) service. The Multimedia Broadcast Multicast Service (MBMS) service area 214 may be divided into one or more Multimedia Broadcast over a Single Frequency Network (MBSFN) areas 216a-c. Each Multimedia Broadcast over a Single Frequency Network (MBSFN) area 216 may include multiple base stations (e.g., eNBs) that can synchronously transmit the same evolved Multicast Broadcast Multimedia Service (eMBMS) contents. Each Multimedia Broadcast over a Single Frequency Network (MBSFN) area 216 can be used to broadcast the venue, regional contents and national contents. One Long Term Evolution (LTE) cell can support a maximum of eight Multimedia Broadcast over a Single Frequency Network (MBSFN) areas 216. For in-venue broadcast, the size of a Multimedia Broadcast over a Single Frequency Network (MBSFN) area 216 may be as small as one cell or as large as tens of cells.

The base stations of each Multimedia Broadcast over a Single Frequency Network (MBSFN) area 216 may transmit Multicast Traffic Channels (MTCHs) and Multicast Control Channels (MCCHs) at the same time. Therefore, the wireless communication device 104 can combine signals broadcast from different base stations (similar to a soft handoff).

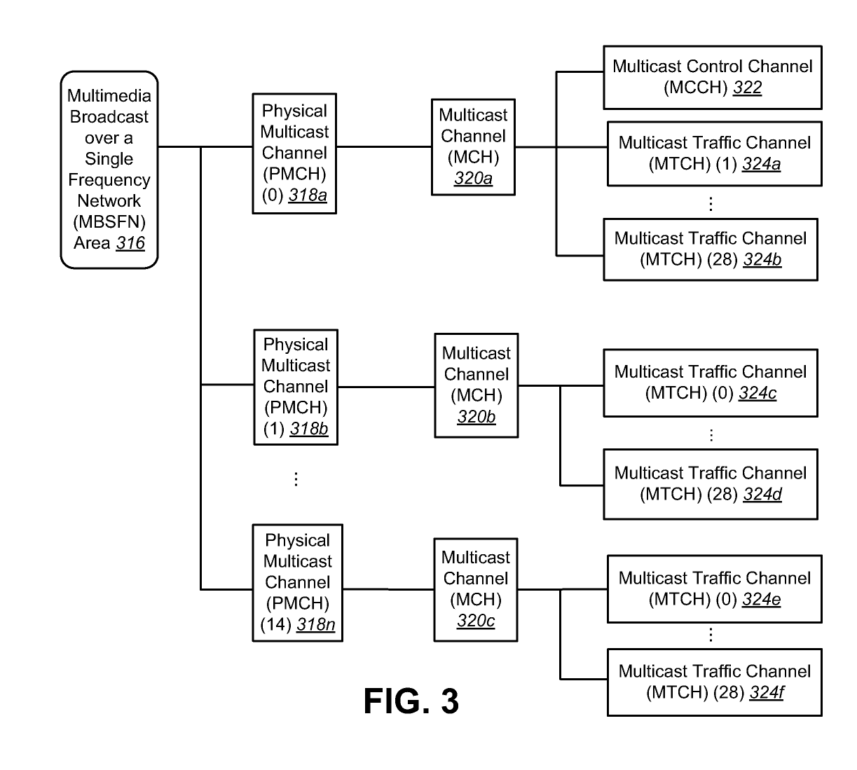

FIG. 3 illustrates the channel structure for a Multimedia Broadcast over a Single Frequency Network (MBSFN) area 316. A Multimedia Broadcast over a Single Frequency Network (MBSFN) area 316 may include up to 15 Physical Multicast Channels (PMCHs) 318a-n. Each Physical Multicast Channel (PMCH) 318 corresponds to a Multicast Channel (MCH) 320a-c transport channel. Each Multicast Channel (MCH) 320 can multiplex up to 29 Multicast Traffic Channel (MTCH) 324a-f logical channels. Each Multimedia Broadcast over a Single Frequency Network (MBSFN) area 316 includes one Multicast Control Channel (MCCH) 322 logical channel, which is multiplexed with the Multicast Traffic Channels (MTCHs) 324 into a Multicast Channel (MCH) 320 associated with a Physical Multicast Channel (PMCH) 318. For example, the Multicast Control Channel (MCCH) 322 may be multiplexed in place of Multicast Traffic Channel (MTCH) (0) in the Multicast Channel (MCH) 320a in Physical Multicast Channel (PMCH) (0) 318a for a single Multimedia Broadcast over a Single Frequency Network (MBSFN) area 316.

To acquire a Multicast Traffic Channel (MTCH) 324, the wireless communication device 104 needs to receive a Session Description of User Service Description of the evolved Multicast Broadcast Multimedia Service (eMBMS) in which the Temporary Mobile Group Identity (TMGI) and the optional Session ID of the interested evolved Multicast Broadcast Multimedia Service (eMBMS) service is specified, as well as the start time of the evolved Multicast Broadcast Multimedia Service (eMBMS) service. The wireless communication device 104 may camp on a Long Term Evolution (LTE) cell to discover the availability of evolved Multicast Broadcast Multimedia Service (eMBMS) services and a corresponding access stratum configuration.

The wireless communication device 104 may first acquire a SIB13 (SystemInformationBlockType13). The SIB13 may indicate the Multimedia Broadcast over a Single Frequency Network (MBSFN) area ID of each Multimedia Broadcast over a Single Frequency Network (MBSFN) area 316 supported by the cell. The SIB13 may also indicate information that may be used to acquire the Multicast Control Channel (MCCH) 322 of the Multimedia Broadcast over a Single Frequency Network (MBSFN) area 316. This information may include the Multicast Control Channel (MCCH) repetition period (32, 64, . . . , 256 frames), the Multicast Control Channel (MCCH) offset (0, 1, . . . , 10 frames), the Multicast Control Channel (MCCH) modification period (512 or 1024 frames), the signaling modulation and coding scheme (MCS), and sf-Alloclnfo, which indicates which subframes of the radio frame, as indicated by the repetition period and the offset, can transmit the Multicast Control Channel (MCCH) 322.

The wireless communication device 104 may then acquire an MBSFNAreaConfiguration message on the Multicast Control Channel (MCCH) 322. The MBSFNAreaConfiguration message may indicate the temporary mobile group identity (TMGI) and optional session ID of each Multicast Traffic Channel (MTCH) 324, which is identified by the logical channel ID (LCID) within the Physical Multicast Channel (PMCH) 318. The MBSFNAreaConfiguration message may also indicate the allocated resources (e.g., radio frames and subframes) for transmitting each Physical Multicast Channel (PMCH) 318 of the Multimedia Broadcast over a Single Frequency Network (MBSFN) area 316 and the allocation period (e.g., 4, 8, . . . , 256 frames) of the allocated resources for all the Physical Multicast Channels (PMCHs) 318 in the Multimedia Broadcast over a Single Frequency Network (MBSFN) area 316. The MBSFNAreaConfiguration may further include the Multicast Channel scheduling period (MSP) over which the Multicast Channel Scheduling Information (MSI) Media Access Control (MAC) control element is transmitted. The Multicast Channel scheduling period (MSP) may be 8, 16, 32, . . . , or 1024 radio frames. In other words, the Multicast Channel Scheduling Information (MSI) Media Access Control (MAC) control element is sent once per Multicast Channel scheduling period (MSP).

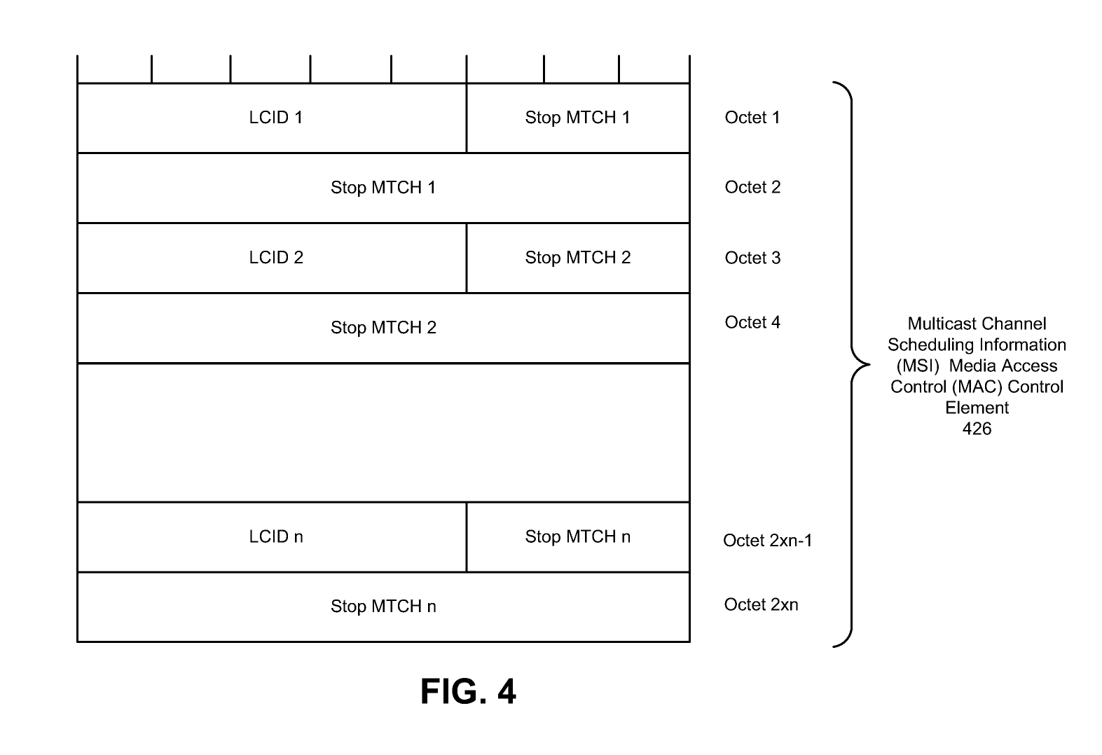

FIG. 4 illustrates one configuration of the format for a Multicast Channel Scheduling Information (MSI) Media Access Control (MAC) control element 426. The Multicast Channel Scheduling Information (MSI) Media Access Control (MAC) control element 426 indicates how multiple Multicast Traffic Channels (MTCHs) 324 associated with one single Physical Multicast Channel (PMCH) 318 are transmitted. As described above, the Multicast Control Channel (MCCH) 322 indicates how multiple Physical Multicast Channels (PMCHs) 318 are transmitted, but there are multiple Multicast Traffic Channels (MTCHs) 324 within one Physical Multicast Channel (PMCH) 318. The transmission of the multiple Multicast Traffic Channels (MTCHs) 324 is indicated by Multicast Channel Scheduling Information (MSI) Media Access Control (MAC) control element 426 (over multiple octets). When a wireless communication device 104 receives the Multicast Channel Scheduling Information (MSI) Media Access Control (MAC) control element 426, the wireless communication device 104 may determine the time schedule to receive on one particular Multicast Traffic Channel (MTCH) 324. The wireless communication device 104 may receive the Multicast Channel Scheduling Information (MSI) Media Access Control (MAC) control element 426 during the Multicast Channel scheduling period (MSP). The Multicast Channel scheduling period (MSP) can only be signaled on the Multicast Control Channel (MCCH) 322 using the MBSFNAreaConfiguration message. This is how the wireless communication device 104 can receive one particular service (e.g., the Multicast Traffic Channel (MTCH) 324).

The Multicast Channel Scheduling Information (MSI) Media Access Control (MAC) control element 426 can indicate different channels. The Multicast Channel Scheduling Information (MSI) Media Access Control (MAC) control element 426 is sent in the first subframe of each Physical Multicast Channel (PMCH) 318 scheduling period. The Multicast Channel Scheduling Information (MSI) Media Access Control (MAC) control element 426 can indicate the stop frame and subframe of each Multicast Traffic Channel (MTCH) 324 within the Physical Multicast Channel (PMCH) 318. Different Multicast Traffic Channels (MTCHs) 324 are identified by different logical channel IDs (LCIDs). For every logical channel ID (LCID), a Stop MTCH parameter indicates the frame number where the associated Multicast Traffic Channel (MTCH) 324 stops.

In one example, a Physical Multicast Channel (PMCH) 318 may have 100 subframes. There may be two Multicast Traffic Channels (MTCHs) 324 within the Physical Multicast Channel (PMCH) 318. The first Multicast Traffic Channel (MTCH) 324 may include 50 subframes and the second Multicast Traffic Channel (MTCH) 324 may include the other 50 subframes for the Physical Multicast Channel (PMCH) 318. The Multicast Channel Scheduling Information (MSI) Media Access Control (MAC) control element 426 will indicate a first logical channel ID (LCID1) (associated with the first Multicast Traffic Channel (MTCH) 324) and the Stop MTCH 1 will equal 49. The Multicast Channel Scheduling Information (MSI) Media Access Control (MAC) control element 426 will also indicate a second logical channel ID (LCID2) (associated with the second Multicast Traffic Channel (MTCH) 324) and the Stop MTCH 2 will equal 99. By knowing the stop of the next Multicast Traffic Channel (MTCH) 324 the wireless communication device 104 can trace the Multicast Traffic Channels (MTCHs) 324 and know when to start receiving and when to stop receiving the Multicast Traffic Channels (MTCHs) 324. The wireless communication device 104 will start to receive from the previous Multicast Traffic Channel (MTCH) 324 subframe number until the current Multicast Traffic Channel (MTCH) 324 subframe number.

FIG. 5 is a block diagram illustrating an evolved Multicast Broadcast Multimedia Service (eMBMS) inter-frequency cell reselection module 512. The evolved Multicast Broadcast Multimedia Service (eMBMS) inter-frequency cell reselection module 512 of FIG. 5 may be one configuration of the evolved Multicast Broadcast Multimedia Service (eMBMS) inter-frequency cell reselection module 112 of FIG. 1. A wireless communication device 104 may use the evolved Multicast Broadcast Multimedia Service (eMBMS) inter-frequency cell reselection module 512 to acquire an evolved Multicast Broadcast Multimedia Service (eMBMS) service on a different frequency of a neighbor cell 106 than the frequency of the serving cell 102.

A wireless communication device 104 may be camped on a serving cell 102 at a serving frequency 528. When the wireless communication device 104 is in idle mode, the wireless communication device 104 periodically measures inter-frequency neighbor cells 106. The neighbor cells 106 may be LTE cells. An evolved Multicast Broadcast Multimedia Service (eMBMS) service that is desired by the wireless communication device 104 (e.g., selected by an operator of the wireless communication device 104 or made available by the network) may be provided by a neighbor cell 106 at a neighbor frequency 530. The wireless communication device 104 may measure inter-frequency parameters 551 of the neighbor cell 106. The inter-frequency parameters 551 may include an RSRQ (reference signal received quality) 553 measurement and an RSRP (reference signal received power) 555 measurement. The wireless communication device 104 can reselect to another frequency (e.g., from the serving frequency 528 to the neighbor frequency 530) if certain inter-frequency cell reselection conditions are met.

The evolved Multicast Broadcast Multimedia Service (eMBMS) inter-frequency cell reselection module 512 may include a low serving threshold 560 that is based on either RSRQ 553 or RSRP 555. If a low serving threshold 560 (referred to as threshServing-LowQ) based on an RSRQ 553 measurement is signaled in SIB3 (System Information Block Type 3), then the low serving threshold 560 is based on the RSRQ 553. If a low serving threshold 560 (referred to as threshServing-LowQ) based on an RSRQ 553 measurement is not signaled in SIB3 (System Information Block Type 3), then the low serving threshold 560 is based on the RSRP 555.

If the low serving threshold 560 is based on the RSRQ 553, then other parameters in the evolved Multicast Broadcast Multimedia Service (eMBMS) inter-frequency cell reselection module 512 may also be based on the RSRQ 553, such as a neighbor cell signal quality 552, a serving cell signal quality 554, a high neighbor threshold 556 (referred to as threshX-HighQ) and a low neighbor threshold 558 (referred to as threshX-LowQ) (e.g., RSRQ 553 is used as the matrix parameter or input variable). Likewise, if the low serving threshold 560 is based on the RSRP 555, then other parameters in the evolved Multicast Broadcast Multimedia Service (eMBMS) inter-frequency cell reselection module 512 may also be based on the RSRP 555, such as the neighbor cell signal quality 552, the serving cell signal quality 554, the high neighbor threshold 556 (referred to as threshX-HighP) and the low neighbor threshold 558 (referred to as threshX-LowP) (e.g., RSRP 555 is used as the matrix parameters or input variable).

The evolved Multicast Broadcast Multimedia Service (eMBMS) inter-frequency cell reselection module 512 may determine whether a neighbor frequency priority 548 is greater than the serving frequency priority 550. Each frequency (including the serving frequency 528 and the neighbor frequency 530) is configured (e.g., by the network) with a priority value in the range {0, 1, . . . , 7}, where a higher value equals a higher priority. Inter-frequency cell reselection may be based on a comparison between the serving frequency priority 550 and the neighbor frequency priority 548. The evolved Multicast Broadcast Multimedia Service (eMBMS) inter-frequency cell reselection module 512 may further include a blocking period 546. The blocking period 546 may be used to prevent very frequent cell reselection. The blocking period 546 is typically one second.

The Treselection time 544 may be used by a hysteresis timer to avoid the ping-pong effect due to radio channel time variation. The Treselection time 544 may also be referred to as Treselection. The Treselection time 544 may be determined based on a Treselection_EUTRAN 540 parameter signaled by the network. The Treselection time 544 may be determined by a Treselection determination module 542. The Treselection time 544 may also depend on the speed at which the wireless communication device 104 is moving.

The network may configure the wireless communication device 104 to scale down the Treselection time 544. Scaling factors may be used to scale down the Treselection time 544 while the wireless communication device 104 is moving at a medium speed or high speed. A medium scaling factor 534 (e.g., sf_Medium) and high scaling factor 536 (e.g., sf_High) can scale Treselection 544 between 25% and 75%. The Treselection time 544 may be determined by Equation (1) for medium speed and Equation (2) for high speed:

Treselection=sf_Medium*Treselection_EUTRAN. (1)

Treselection=sf_High*Treselection_EUTRAN. (2)

The Treselection_EUTRAN 540 parameter is signaled in SIBS. The medium scaling factor 534 and high scaling factor 536 are signaled in SIB3.

In a multi-band LTE network, an evolved Multicast Broadcast Multimedia Service (eMBMS) service can be deployed on multiple frequencies. For example, two frequencies may be on the same band or two frequencies may be on different bands. In one configuration, the serving frequency 528 may be 700 MHz and the neighbor frequency 530 may be in a different band at 1900 MHz. In another configuration, the serving frequency 528 and the neighbor frequency 530 may be in the same band (e.g., each frequency 528, 530 may be slightly different frequencies).

The wireless communication device 104 will use the frequency information to acquire evolved Multicast Broadcast Multimedia Service (eMBMS) service transmitted on the Multicast Traffic Channel (MTCH) 324 on a given frequency (e.g., the neighbor frequency 530). The frequency information of an evolved Multicast Broadcast Multimedia Service (eMBMS) service is signaled in the User Service Description (USD) of a service announcement, where the TMGI (Temporary Mobile Group Identity) and the associated frequency channel information are configured.

The wireless communication device 104 in idle mode follows an inter-frequency cell reselection procedure to change frequency. However, this becomes problematic when the wireless communication device 104 is interested in receiving an evolved Multicast Broadcast Multimedia Service (eMBMS) service on another frequency. The wireless communication device 104 may set the neighbor frequency 530 with the evolved Multicast Broadcast Multimedia Service (eMBMS) service to the highest priority. If the wireless communication device 104 has knowledge of which frequency an evolved Multicast Broadcast Multimedia Service (eMBMS) service of interest is provided on, the wireless communication device 104 may consider that frequency to be the highest priority during an evolved Multicast Broadcast Multimedia Service (eMBMS) session. In this way, the wireless communication device 104 may prioritize the evolved Multicast Broadcast Multimedia Service (eMBMS) service and reselect to the neighbor frequency 530.

However, the inter-frequency cell reselection procedure still needs to meet the Treselection time 544 and blocking period 546 conditions before an inter-frequency cell reselection can be performed. The Treselection time 544 can be in the range of zero to seven seconds. Therefore, if a user has chosen the evolved Multicast Broadcast Multimedia Service (eMBMS) service, the evolved Multicast Broadcast Multimedia Service (eMBMS) service can take, at a minimum, the Treselection time 544 or the blocking period 546 (whichever is longer) before starting to change frequency and acquire the evolved Multicast Broadcast Multimedia Service (eMBMS) service. In the event of a long Treselection time 544 (e.g., seven seconds), such a long delay may result in a poor user experience (e.g., a long delay while watching real-time video streaming). Therefore, it may desirable to improve the latency for receiving evolved Multicast Broadcast Multimedia Service (eMBMS) services on another frequency.

To reduce the delay associated with the inter-frequency cell reselection procedure, the evolved Multicast Broadcast Multimedia Service (eMBMS) inter-frequency cell reselection module 512 may determine whether to perform an inter-frequency cell reselection based on one or more inter-frequency cell reselection factors (such as setting the blocking period 546 to a value less than one (e.g., zero), reducing the Treselection time 544 based on whether a user chooses the new evolved Multicast Broadcast Multimedia Service (eMBMS) service (e.g., reducing the Treselection time 544 to zero), reducing the Treselection time 544 based on a scaling factor irrespective of the wireless communication device 104 speed and reducing the Treselection time 544 based on an eMBMS scaling factor 538).

The systems and methods described herein may allow the wireless communication device 104 to perform fast inter-frequency cell reselection. The systems and methods described herein may reduce the delay to establish an evolved Multicast Broadcast Multimedia Service (eMBMS) service on another frequency when the wireless communication device 104 is idle mode.

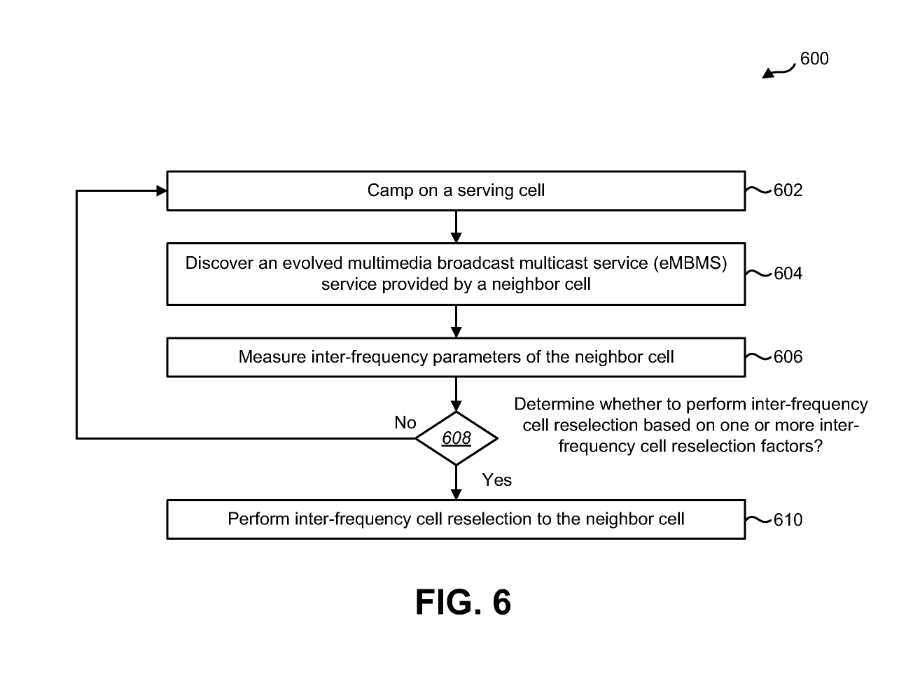

FIG. 6 is a flow diagram of a method 600 for evolved Multicast Broadcast Multimedia Service (eMBMS) inter-frequency cell reselection. The method 600 may be performed by a wireless communication device 104. The wireless communication device 104 may camp 602 on a serving cell 102. In one implementation, the wireless communication device 104 may camp 602 on the serving cell 102 in idle mode.

The wireless communication device 104 may discover 604 an evolved Multicast Broadcast Multimedia Service (eMBMS) service provided by a neighbor cell 106. In one configuration, the wireless communication device 104 may discover 604 an evolved Multicast Broadcast Multimedia Service (eMBMS) service by acquiring an SIB13 (SystemInformationBlockType13) and an MBSFNAreaConfiguration message on the Multicast Control Channel (MCCH) 322. This may be accomplished as described in relation to FIG. 3. The neighbor frequency 530 may be different than the serving frequency 528.

The wireless communication device 104 may measure 606 inter-frequency parameters 551 of the neighbor cell 106. When the wireless communication device 104 is in idle mode, the wireless communication device 104 may periodically measure inter-frequency neighbor cells 106. The inter-frequency parameters 551 measured by the wireless communication device 104 may include the RSRQ 553 and the RSRP 555 associated with the neighbor cell 106.

The wireless communication device 104 may determine 608 whether to perform inter-frequency cell reselection based on one or more cell reselection factors. In a first configuration, an inter-frequency cell reselection factor may include setting the blocking period 546 to a value less than one second. For example, the blocking period 546 may be set to zero seconds. If the wireless communication device 104 is camped on a serving cell 102 and a new evolved Multicast Broadcast Multimedia Service (eMBMS) service is known to be provided on another frequency (e.g., the neighbor frequency 530), the inter-frequency cell reselection procedure does not require a blocking period 546 for being camped on the serving cell 102. The wireless communication device 104 can immediately perform 610 an inter-frequency cell reselection to the neighbor cell 106 if the remaining inter-frequency cell reselection conditions are met. It should be noted that the inter-frequency cell reselection factor in this configuration is speed-independent. In other words, the value of the blocking period 546 is set irrespective of the speed that the wireless communication device 104 may be moving.

In a second configuration, the inter-frequency cell reselection factor may include reducing the Treselection time 544 based on whether a user chooses the new evolved Multicast Broadcast Multimedia Service (eMBMS) service. In this configuration, a user indicates interest in an evolved Multicast Broadcast Multimedia Service (eMBMS) service that is known to be provided on another frequency. The user may indicate interest in the evolved Multicast Broadcast Multimedia Service (eMBMS) service through a service request. The wireless communication device 104 may know that the evolved Multicast Broadcast Multimedia Service (eMBMS) service is on another frequency because the User Service Description (USD) indicates the frequency information. The Treselection determination module 542 may set the Treselection time 544 to zero.

The wireless communication device 104 can immediately perform signal measurement. As soon as the remaining inter-frequency cell reselection conditions are met, the wireless communication device 104 can immediately perform 610 inter-frequency cell reselection. In other words, once the wireless communication device 104 determines that the neighbor frequency 530 is good and the other remaining inter-frequency cell reselection conditions are met (e.g., the blocking period 546 has expired), then the wireless communication device 104 may perform 610 inter-frequency cell reselection. Therefore, the inter-frequency cell reselection factor may include setting the Treselection time 544 to zero. It should be noted that the inter-frequency cell reselection factor in this configuration is also independent of the wireless communication device 104 speed. In other words, the Treselection time 544 is set to zero irrespective of the speed that the wireless communication device 104 may be moving.

In a third configuration, the inter-frequency cell reselection factor may include reducing the Treselection time 544 based on a scaling factor irrespective of the wireless communication device 104 speed. The scaling factor may be the high scaling factor 536 that is signaled in SIB3. In some circumstances the signal from the neighbor frequency 530 is time-varying. The neighbor cell signal quality 552 may fluctuate between being bad and good. In this case the wireless communication device 104 may need to check the neighbor cell signal quality 552 for more time. A scaling factor (e.g., the high scaling factor 536) may be used to scale down the Treselection time 544. In this configuration, the scaling factor is used to scale down the Treselection time 544 irrespective of the wireless communication device 104 speed.

The scaling factor may be used to scale down the Treselection time 544 from the original value to a smaller value as described above in Equation (2). The scaling factor is a network configured value. For example, the high scaling factor 536 could be 25%. The high scaling factor 536 could be used to scale down the Treselection time 544 irrespective of wireless communication device 104 speed. For example, the wireless communication device 104 may be moving at a slow speed where the high scaling factor 536 typically would not be used. However, if the wireless communication device 104 is interested in receiving evolved Multicast Broadcast Multimedia Service (eMBMS) service on another frequency, then the Treselection time 544 may be scaled down by using the network configured high scaling factor 536.

Upon expiration of the Treselection time 544, the wireless communication device 104 can perform 610 an inter-frequency cell reselection to the neighbor cell 106 if the remaining inter-frequency cell reselection conditions are met.

In a fourth configuration, the inter-frequency cell reselection factor may include reducing the Treselection time 544 based on an eMBMS scaling factor 538. The eMBMS scaling factor 538 may be a new scaling factor (e.g., sf eMBMS). In one implementation, the eMBMS scaling factor 538 may be used to scale down the Treselection time 544 when the wireless communication device 104 is interested in an evolved Multicast Broadcast Multimedia Service (eMBMS) service, irrespective of the wireless communication device 104 speed. The Treselection time 544 may be determined as shown in Equation (3):

Treselection=sf_eMBMS*Treselection_EUTRAN. (3)

In Equation (3), Treselection_EUTRAN 540 may be signaled by the network in SIBS. The eMBMS scaling factor 538 may be any non-zero factor. For example, the eMBMS scaling factor 538 may be 10% (e.g., 0.1) or 25% (e.g., 0.25). In one implementation, the eMBMS scaling factor 538 may be a configuration parameter and the base station or network can set the value for the configuration parameter.

In another implementation, the inter-frequency cell reselection factor may include reducing the Treselection time 544 based on an eMBMS scaling factor 538 and a speed-dependent scaling factor. Therefore, the Treselection time 544 may be scaled for speed and the additional eMBMS scaling factor. The Treselection time 544 may be determined by Equation (4) for medium speed and Equation (5) for high speed:

Treselection=sf_eMBMS*sf_Medium*Treselection_EUTRAN (4)

Treselection=sf_eMBMS*sf_High*Treselection_EUTRAN. (5)

The one or more inter-frequency cell reselection factors described in the above configurations may be used independently or in combination with each other. For example, the blocking period 546 may be set to zero and the Treselection time 544 may also be set to zero. In another example, the blocking period 546 may be set to zero and the Treselection time 544 may be reduced based on a scaling factor (e.g., high scaling factor 536 or eMBMS scaling factor 538) irrespective of the wireless communication device 104 speed.

Upon expiration of the Treselection time 544, the wireless communication device 104 can perform 610 an inter-frequency cell reselection to the neighbor cell 106 if the remaining inter-frequency cell reselection conditions are met, as described above in relation to FIG. 5. If the wireless communication device 104 determines 608 to not perform inter-frequency cell reselection, the wireless communication device 104 may continue to camp 602 on the serving cell 102.

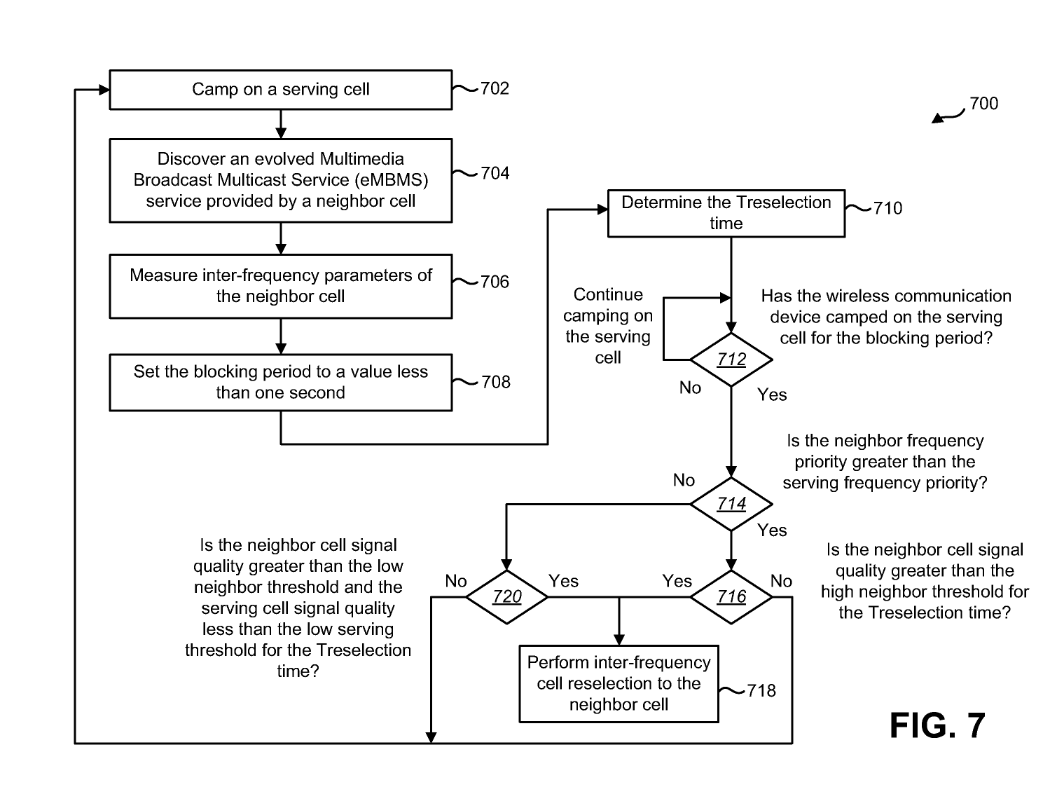

FIG. 7 is a flow diagram illustrating a detailed configuration of a method 700 for evolved Multicast Broadcast Multimedia Service (eMBMS) inter-frequency cell reselection. The method 700 may be performed by a wireless communication device 104. The wireless communication device 104 may camp 702 on a serving cell 102. The wireless communication device 104 may discover 704 an evolved Multicast Broadcast Multimedia Service (eMBMS) service provided by a neighbor cell 106. The wireless communication device 104 may measure 706 inter-frequency parameters 551 of the neighbor cell 106. The inter-frequency parameters 551 measured 706 by the wireless communication device 104 may include the RSRQ 553 and the RSRP 555 associated with the neighbor cell 106.

The wireless communication device 104 may set 708 the blocking period 546 to a value less than one second. For example, the blocking period 546 may be set to zero seconds. The wireless communication device 104 may determine 710 the Treselection time 544. This may be accomplished as described above in relation to FIG. 5. For example, the Treselection time 544 may be based on the Treselection_EUTRAN 540 parameter signaled by the network. If the wireless communication device 104 is moving, the Treselection time 544 may also be based on a speed-dependent scaling factor (e.g., a medium scaling factor 534 or a high scaling factor 536) as described above in Equation (1) and Equation (2).

The wireless communication device 104 may determine 712 whether the wireless communication device 104 has camped on the serving cell 102 for the blocking period 546. If the wireless communication device 104 has not camped on the serving cell 102 for the blocking period 546, then the wireless communication device 104 may continue camping on the serving cell 102. It should be noted that the blocking period 546 may be set 708 to zero seconds.

If it is determined 712 that the wireless communication device 104 has camped on the serving cell 102 for the blocking period 546, the wireless communication device 104 may then determine 714 whether the neighbor frequency priority 548 is greater than the serving frequency priority 550. If the neighbor frequency priority 548 is greater than the serving frequency priority 550, then the wireless communication device 104 may determine 716 whether the neighbor cell signal quality 552 (based on either the RSRQ 553 or the RSRP 555) is greater than a high neighbor threshold 556 (e.g., threshX-HighQ or threshX-HighP) for the Treselection time 544. In some configurations, the wireless communication device 104 may take one or more neighbor cell signal quality 552 measurements over the Treselection time 544. Each of the neighbor cell signal quality 552 measurements taken during the Treslection time 544 must be greater than the high neighbor threshold 556 before the wireless communication device 104 determines 716 that the neighbor cell signal quality 552 is greater than the high neighbor threshold 556.

In one scenario, a low serving threshold 560 based on the RSRQ 553 measurement is signaled in SIB3 (System Information Block Type 3). In this scenario, the neighbor cell signal quality 552 and the high neighbor threshold 556 are based on the RSRQ 553. The high neighbor threshold 556 may be referred to as threshX-HighQ. Therefore, the wireless communication device 104 may determine 716 whether the neighbor cell signal quality 552 based on the RSRQ 553 is greater than threshX-HighQ for the Treselection time 544.

In another scenario, a low serving threshold 560 based on the RSRQ 553 measurement is not signaled in SIB3 (System Information Block Type 3). In this scenario, the neighbor cell signal quality 552 and the high neighbor threshold 556 are based on the RSRP 555. The high neighbor threshold 556 may then be referred to as threshX-HighP. Therefore, the wireless communication device 104 may determine 716 whether the neighbor cell signal quality 552 based on the RSRP 555 is greater than threshX-HighP for the Treselection time 544.

If the wireless communication device 104 determines 716 that the neighbor cell signal quality 552 is greater than the high neighbor threshold 556 for the Treselection time 544, then the wireless communication device 104 may perform 718 inter-frequency cell reselection to the neighbor cell 106. However, if the neighbor cell signal quality 552 is not greater than the high neighbor threshold 556 for the Treselection time 544, then the wireless communication device 104 may continue to camp 702 on the serving cell 102.

If the wireless communication device 104 determines 714 that the neighbor frequency priority 548 is not greater than the serving frequency priority 550, then the wireless communication device 104 may determine 720 whether the neighbor cell signal quality 552 is greater than a low neighbor threshold 558 and whether the serving cell signal quality 554 is less than the low serving threshold 560 for the Treselection time 544.

If the low serving threshold 560 based on the RSRQ 553 measurement is signaled in SIB3 (System Information Block Type 3), then the neighbor cell signal quality 552 and the low neighbor threshold 558 are based on the RSRQ 553. The low neighbor threshold 558 may then be referred to as threshX-LowQ and the low serving threshold 560 may be referred to as threshServing-LowQ. Therefore, the wireless communication device 104 may determine 720 whether the neighbor cell signal quality 552 based on the RSRQ 553 is greater than threshX-LowQ and whether the serving cell signal quality 554 is less than threshServing-LowQ for the Treselection time 544.

If the low serving threshold 560 based on the RSRQ 553 measurement is not signaled in SIB3 (System Information Block Type 3), then the neighbor cell signal quality 552, the low neighbor threshold 558 and the low serving threshold 560 are based on the RSRP 555. The low neighbor threshold 558 may then be referred to as threshX-LowP and the low serving threshold 560 may be referred to as threshServing-LowP. Therefore, the wireless communication device 104 may determine 720 whether the neighbor cell signal quality 552 based on the RSRP 555 is greater than threshX-LowP and whether the serving cell signal quality 554 is less than threshServing-LowP for the Treselection time 544.

If the wireless communication device 104 determines 720 that the neighbor cell signal quality 552 is greater than the low neighbor threshold 558 and the serving cell signal quality 554 is less than the low serving threshold 560 for the Treselection time 544, then the wireless communication device 104 may perform 718 inter-frequency cell reselection to the neighbor cell 106. However, if the neighbor cell signal quality 552 is not greater than the low neighbor threshold 558 or the serving cell signal quality 554 is not less than the low serving threshold 560 for the Treselection time 544, then the wireless communication device 104 may continue to camp 702 on the serving cell 102.

It should be noted that although the steps illustrated in FIG. 7 are described sequentially, the steps may occur concurrently. For example, steps 712, 714, 716 and/or 720 may occur concurrently.

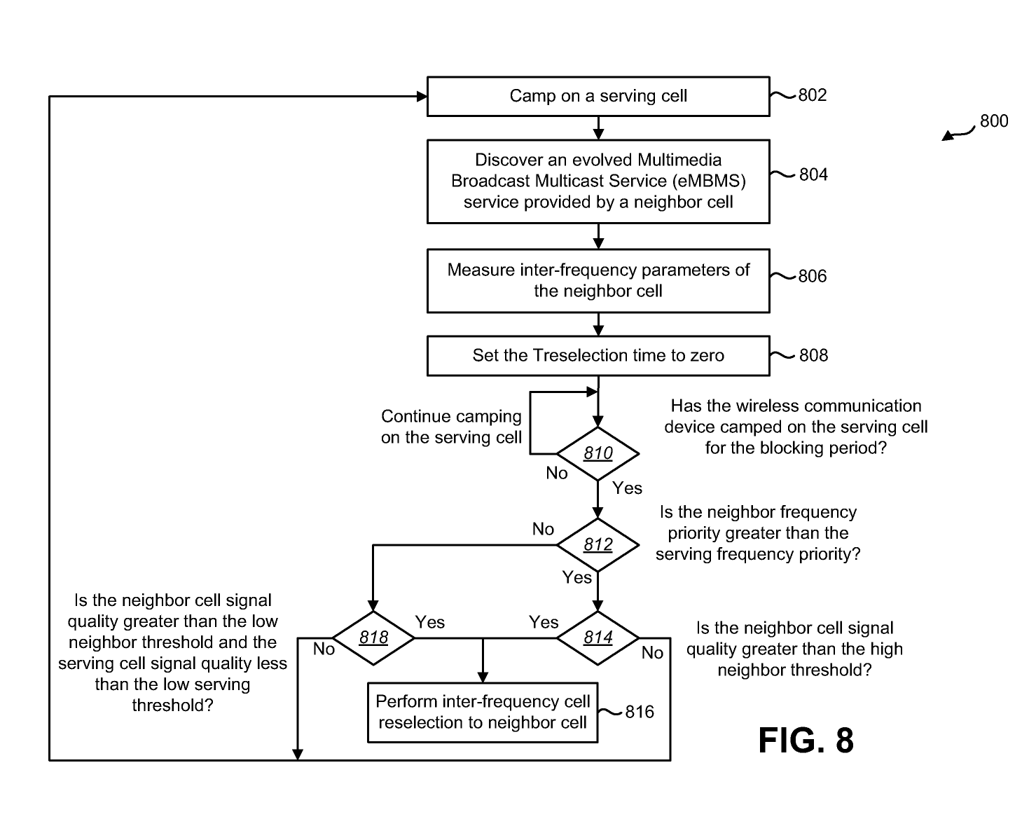

FIG. 8 is a flow diagram illustrating another detailed configuration of a method 800 for evolved Multicast Broadcast Multimedia Service (eMBMS) inter-frequency cell reselection. The method 800 may be performed by a wireless communication device 104. The wireless communication device 104 may camp 802 on a serving cell 102. The wireless communication device 104 may discover 804 an evolved Multicast Broadcast Multimedia Service (eMBMS) service provided by a neighbor cell 106. The wireless communication device 104 may measure 806 inter-frequency parameters 551 of the neighbor cell 106. The inter-frequency parameters 551 measured by the wireless communication device 104 may include the RSRQ 553 and the RSRP 555 associated with the neighbor cell 106.

The wireless communication device 104 may set 808 the Treselection time 544 to zero. In one configuration, the wireless communication device 104 may set 808 the Treselection time 544 to zero based on whether a user chooses the evolved Multicast Broadcast Multimedia Service (eMBMS) service. For example, if a user makes an evolved Multicast Broadcast Multimedia Service (eMBMS) service request, the wireless communication device 104 may set 808 the Treselection time 544 to zero. It should be noted that in this configuration, the wireless communication device 104 replaces a network configured value of the Treselection time 544 with zero.

The wireless communication device 104 may determine 810 whether the wireless communication device 104 has camped on the serving cell 102 for the blocking period 546. If the wireless communication device 104 has not camped on the serving cell 102 for the blocking period 546, then the wireless communication device 104 continues camping on the serving cell 102.

If it is determined 810 that the wireless communication device 104 has camped on the serving cell 102 for the blocking period 546, then the wireless communication device 104 may determine 812 whether the neighbor frequency priority 548 is greater than the serving frequency priority 550. If the neighbor frequency priority 548 is greater than the serving frequency priority 550, then the wireless communication device 104 may determine 814 whether the neighbor cell signal quality 552 is greater than a high neighbor threshold 556. This may be accomplished as described above in relation to FIG. 7. However, it should be noted that in this configuration, the Treselection time 544 is equal to zero. Therefore, if the neighbor cell signal quality 552 is greater than the high neighbor threshold 556, the wireless communication device 104 may immediately perform 816 inter-frequency cell reselection to the neighbor cell 106. If the neighbor cell signal quality 552 is not greater than the high neighbor threshold 556, then the wireless communication device 104 may continue to camp 802 on the serving cell 102.

If the wireless communication device 104 determines 812 that the neighbor frequency priority 548 is not greater than the serving frequency priority 550, then the wireless communication device 104 may determine 818 whether the neighbor cell signal quality 552 is greater than a low neighbor threshold 558 and whether the serving cell signal quality 554 is less than the low serving threshold 560. This may be accomplished as described above in relation to FIG. 7. However, it should be noted that in this configuration, the Treselection time 544 is equal to zero. Therefore, if the neighbor cell signal quality 552 is greater than a low neighbor threshold 558 and if the serving cell signal quality 554 is less than the low serving threshold 560, the wireless communication device 104 may immediately perform 816 inter-frequency cell reselection to the neighbor cell 106. However, if the neighbor cell signal quality 552 is not greater than the low neighbor threshold 558 or the serving cell signal quality 554 is not less than the low serving threshold 560, then the wireless communication device 104 may continue to camp 802 on the serving cell 102.

It should be noted that although the steps illustrated in FIG. 8 are described sequentially, the steps may occur concurrently. For example, steps 810, 812, 814 and/or 818 may occur concurrently.

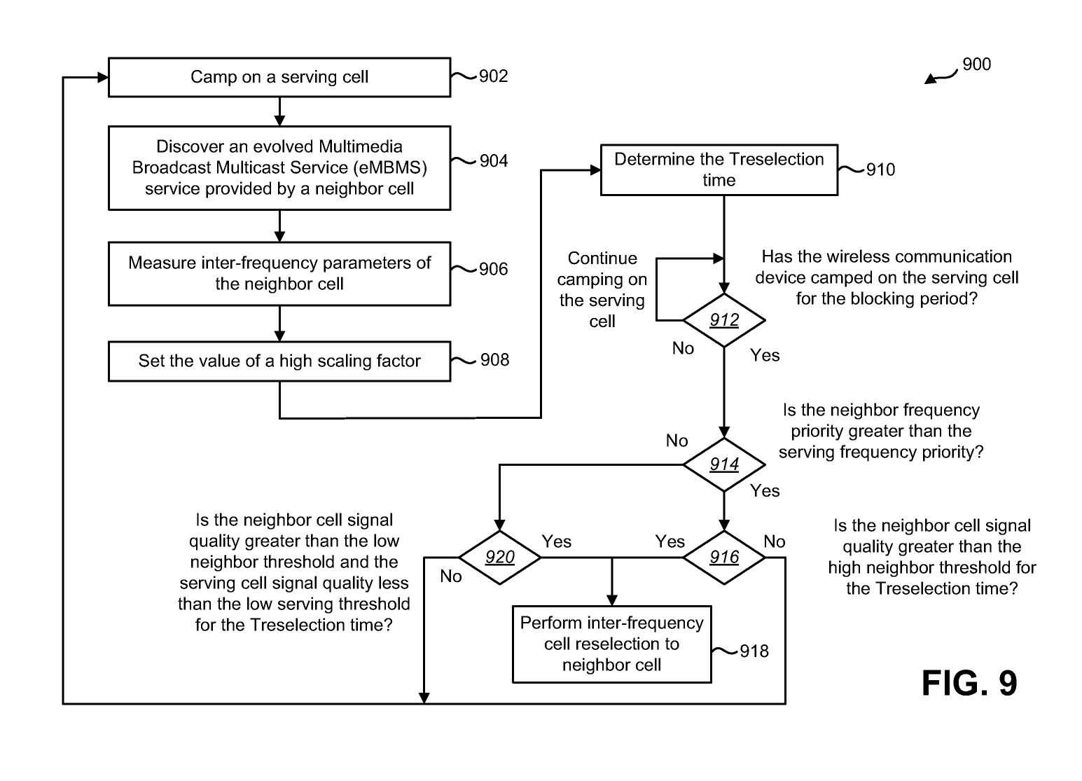

FIG. 9 is a flow diagram illustrating yet another detailed configuration of a method 900 for evolved Multicast Broadcast Multimedia Service (eMBMS) inter-frequency cell reselection. The method 900 may be performed by a wireless communication device 104. The wireless communication device 104 may camp 902 on a serving cell 102. The wireless communication device 104 may discover 904 an evolved Multicast Broadcast Multimedia Service (eMBMS) service provided by a neighbor cell 106. The wireless communication device 104 may measure 906 inter-frequency parameters 551 of the neighbor cell 106. The inter-frequency parameters 551 measured by the wireless communication device 104 may include the RSRQ 553 and the RSRP 555 associated with the neighbor cell 106.

The wireless communication device 104 may set 908 the value of a high scaling factor 536. The high scaling factor 536 may be set 908 irrespective of the wireless communication device 104 speed. The high scaling factor 536 may be sf_High that is signaled in SIB3. However, the use of the high scaling factor 536 in this configuration is independent of the wireless communication device 104 speed (e.g., the high scaling factor 536 may be used even if the wireless communication device 104 is not moving or moving slowly).

The wireless communication device 104 may determine 910 the Treselection time 544. The high scaling factor 536 may be used to scale down the Treselection time 544 from an original value to a smaller value as described above in Equation (2). However, in this configuration, the high scaling factor 536 is used to scale down the Treselection time 544 irrespective of the wireless communication device 104 speed.

The wireless communication device 104 may determine 912 whether the wireless communication device 104 has camped on the serving cell 102 for the blocking period 546. If the wireless communication device 104 has not camped on the serving cell 102 for the blocking period 546, then the wireless communication device 104 continues camping on the serving cell 102.

The wireless communication device 104 may determine 914 whether the neighbor frequency priority 548 is greater than the serving frequency priority 550. If the neighbor frequency priority 548 is greater than the serving frequency priority 550, then the wireless communication device 104 may determine 916 whether the neighbor cell signal quality 552 is greater than the high neighbor threshold 556 for the Treselection time 544. This may be accomplished as described above in relation to FIG. 7. However, it should be noted that in this configuration, the Treselection time 544 is reduced by the high scaling factor 536. Therefore, if the neighbor cell signal quality 552 is greater than the high neighbor threshold 556 for the Treselection time 544, the wireless communication device 104 may perform 918 inter-frequency cell reselection to the neighbor cell 106. If the neighbor cell signal quality 552 is not greater than the high neighbor threshold 556 for the Treselection time 544, then the wireless communication device 104 may continue to camp 902 on the serving cell 102.

If the wireless communication device 104 determines 914 that the neighbor frequency priority 548 is not greater than the serving frequency priority 550, then the wireless communication device 104 may determine 920 whether the neighbor cell signal quality 552 is greater than the low neighbor threshold 558 and whether the serving cell signal quality 554 is less than the low serving threshold 560 for the Treselection time 544. This may be accomplished as described above in relation to FIG. 7. However, it should be noted that in this configuration, the Treselection time 544 is reduced by the high scaling factor 536. If the neighbor cell signal quality 552 is greater than a low neighbor threshold 558 and if the serving cell signal quality 554 is less than the low serving threshold 560 for the Treselection time 544, the wireless communication device 104 may perform 918 inter-frequency cell reselection to the neighbor cell 106. However, if the neighbor cell signal quality 552 is not greater than the low neighbor threshold 558 or the serving cell signal quality 554 is not less than the low serving threshold 560 for the Treselection time 544, then the wireless communication device 104 may continue to camp 902 on the serving cell 102.

It should be noted that although the steps illustrated in FIG. 9 are described sequentially, the steps may occur concurrently. For example, steps 912, 914, 916 and/or 920 may occur concurrently.

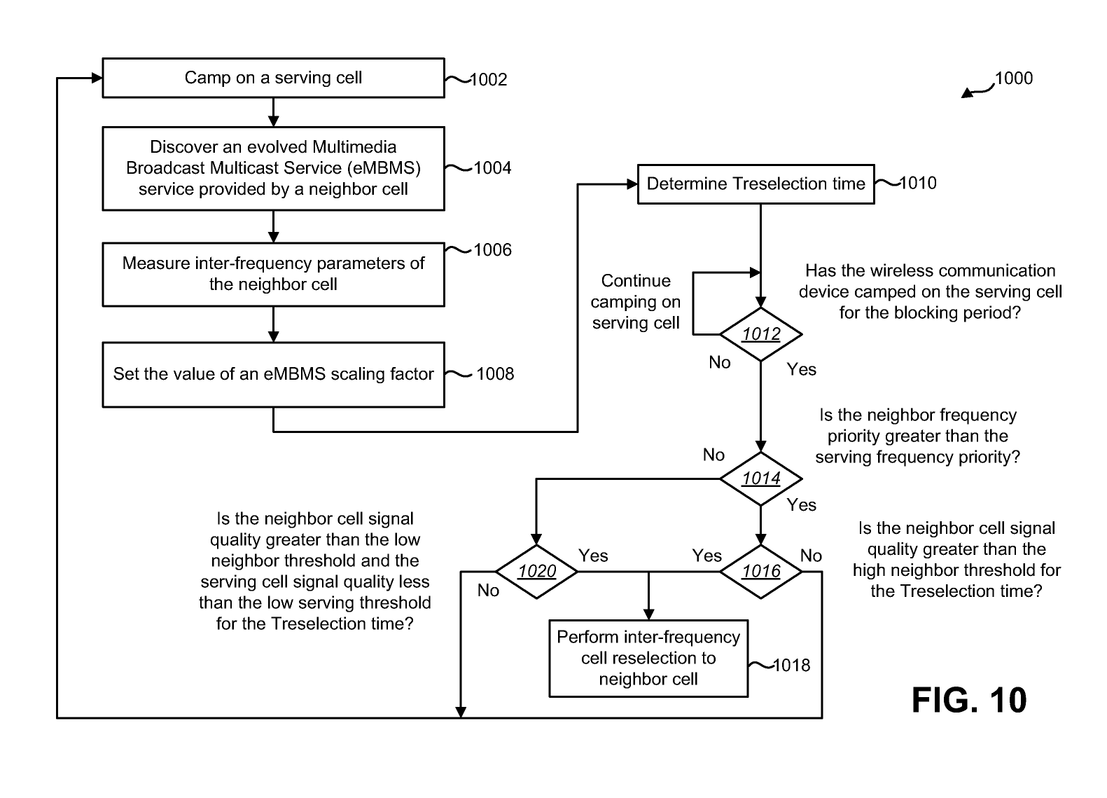

FIG. 10 is a flow diagram illustrating another detailed configuration of a method 1000 for evolved Multicast Broadcast Multimedia Service (eMBMS) inter-frequency cell reselection. The method 1000 may be performed by a wireless communication device 104. The wireless communication device 104 may camp 1002 on a serving cell 102. The wireless communication device 104 may discover 1004 an evolved Multicast Broadcast Multimedia Service (eMBMS) service provided by a neighbor cell 106. The wireless communication device 104 may measure 1006 inter-frequency parameters 551 of the neighbor cell 106. The inter-frequency parameters 551 measured by the wireless communication device 104 may include the RSRQ 553 and the RSRP 555 associated with the neighbor cell 106.

The wireless communication device 104 may set 1008 the value of an eMBMS scaling factor 538. The eMBMS scaling factor 538 may be a new scaling factor (e.g., sf—eMBMS). The eMBMS scaling factor 538 may be set 1008 irrespective of the wireless communication device 104 speed.

The wireless communication device 104 may determine 1010 the Treselection time 544. The eMBMS scaling factor 538 may be used to scale down the Treselection time 544 from an original value to a smaller value as described above in Equation (3). In one implementation, the eMBMS scaling factor 538 may be used to scale down the Treselection time 544 irrespective of the wireless communication device 104 speed. In another implementation, the eMBMS scaling factor 538 and a speed-dependent scaling factor may be used to scale down the Treselection time 544 when the wireless communication device 104 is interested in an evolved Multicast Broadcast Multimedia Service (eMBMS) service. In this case, the Treselection time 544 may be determined as shown in Equation (4) and Equation (5) above.

The wireless communication device 104 may determine 1012 whether the wireless communication device 104 has been camped on the serving cell 102 for the blocking period 546. If the wireless communication device 104 has not camped on the serving cell 102 for the blocking period 546, then the wireless communication device 104 continues camping on the serving cell 102.

If the wireless communication device 104 has camped on the serving cell 102 for the blocking period 546, then the wireless communication device 104 may determine 1014 whether the neighbor frequency priority 548 is greater than the serving frequency priority 550. If the neighbor frequency priority 548 is greater than the serving frequency priority 550, then the wireless communication device 104 may determine 1016 whether the neighbor cell signal quality 552 is greater than the high neighbor threshold 556 for the Treselection time 544. This may be accomplished as described above in relation to FIG. 7. However, it should be noted that in one implementation, the Treselection time 544 is reduced by the eMBMS scaling factor 538 and in another implementation, the Treselection time 544 is reduced by the eMBMS scaling factor 538 and a speed-dependent scaling factor. If the neighbor cell signal quality 552 is greater than the high neighbor threshold 556 for the Treselection time 544, the wireless communication device 104 may perform 1018 inter-frequency cell reselection to the neighbor cell 106. If the neighbor cell signal quality 552 is not greater than the high neighbor threshold 556 for the Treselection time 544, then the wireless communication device 104 may continue to camp 1002 on the serving cell 102.

If the wireless communication device 104 determines 1014 that the neighbor frequency priority 548 is not greater than the serving frequency priority 550, then the wireless communication device 104 may determine 1020 whether the neighbor cell signal quality 552 is greater than the low neighbor threshold 558 and whether the serving cell signal quality 554 is less than the low serving threshold 560 for the Treselection time 544. This may be accomplished as described above in relation to FIG. 7. However, it should be noted that in one implementation, the Treselection time 544 is reduced by the eMBMS scaling factor 538 and in another implementation the Treselection time 544 is reduced by the eMBMS scaling factor 538 and a speed dependent scaling factor. If the neighbor cell signal quality 552 is greater than the low neighbor threshold 558 and if the serving cell signal quality 554 is less than the low serving threshold 560 for the Treselection time 544, the wireless communication device 104 may perform 1018 inter-frequency cell reselection to the neighbor cell 106. However, if the neighbor cell signal quality 552 is not greater than the low neighbor threshold 558 or the serving cell signal quality 554 is not less than the low serving threshold 560 for the Treselection time 544, then the wireless communication device 104 may continue to camp 1002 on the serving cell 102.

It should be noted that although the steps illustrated in FIG. 10 are described sequentially, the steps may occur concurrently. For example, steps 1012, 1014, 1016 and/or 1020 may occur concurrently.

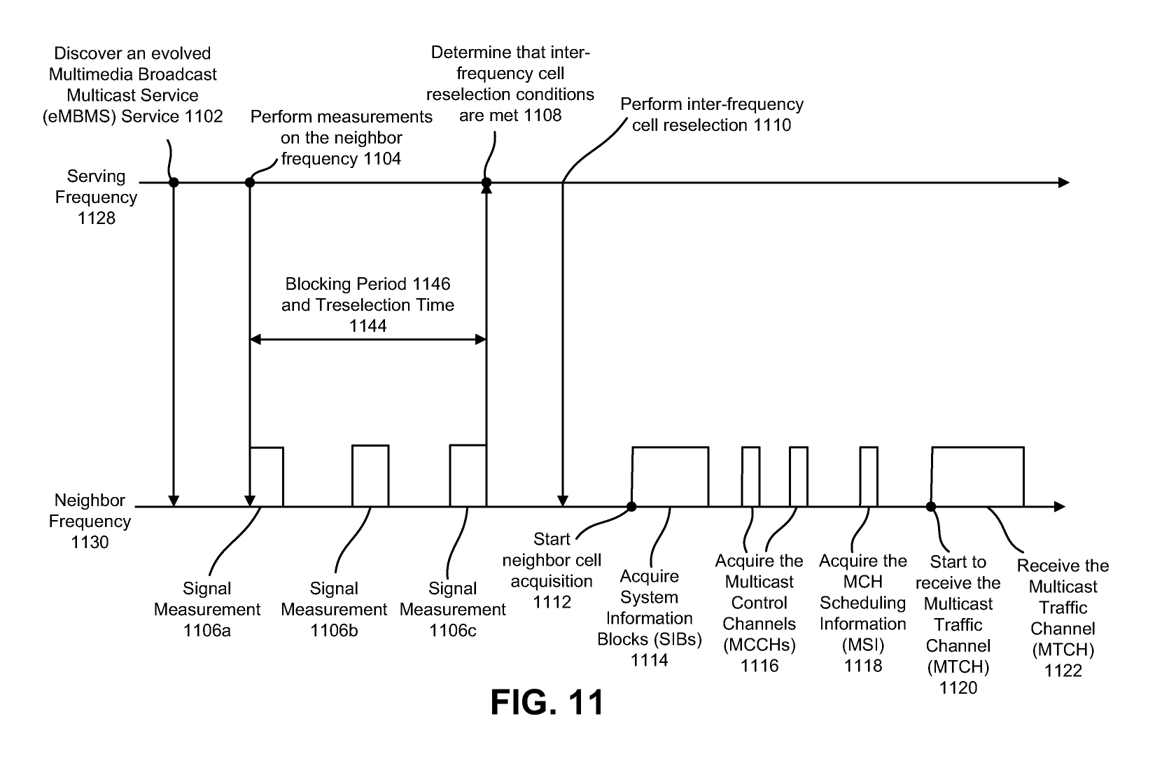

FIG. 11 is a thread diagram illustrating one example of evolved Multicast Broadcast Multimedia Service (eMBMS) inter-frequency cell reselection. A wireless communication device 104 may be camped on a serving cell 102 on a serving frequency 1128. The wireless communication device 104 may be camped in idle mode. The wireless communication device 104 may discover 1102 an evolved Multicast Broadcast Multimedia Service (eMBMS) service provided by a neighbor cell 106. In one configuration, the wireless communication device 104 may discover 1102 the evolved Multicast Broadcast Multimedia Service (eMBMS) service by acquiring an SIB13 (SystemInformationBlockType_{—}13) and an MBSFNAreaConfiguration message on the Multicast Control Channel (MCCH) 322 as described in relation to FIG. 3. In one configuration, the wireless communication device 104 may receive an evolved Multicast Broadcast Multimedia Service (eMBMS) service request from a user.

The wireless communication device 104 may perform 1104 measurements on the neighbor frequency 1130 as described above in relation to FIG. 5. For example, a neighbor cell signal quality 552 may be determined through one or more signal measurements 1106a-c. The wireless communication device 104 may perform 1104 measurements on the neighbor frequency 1130 based on inter-frequency parameters 551 (e.g., the RSRQ 553 and the RSRP 555).

The wireless communication device 104 may continue to obtain signal measurements 1106a-c during a blocking period 1146 and a Treselection time 1144. It should be noted that the systems and methods described herein may reduce or eliminate the blocking period 1146 and/or the Treselection time 1144. For example, an inter-frequency cell reselection factor may include setting the blocking period 1146 to a value less than one second. Another inter-frequency cell reselection factor may include reducing the Treselection time 1144 based on whether a user chooses the new evolved Multicast Broadcast Multimedia Service (eMBMS) service. Yet another inter-frequency cell reselection factor may include reducing the Treselection time 1144 based on a scaling factor irrespective of the wireless communication device 104 speed. Another inter-frequency cell reselection factor may include reducing the Treselection time 1144 based on an eMBMS scaling factor 538.

Upon expiration of the blocking period 1146 and the Treselection time 1144, the wireless communication device 104 may determine 1108 that inter-frequency cell reselection conditions are met. In one configuration, if the wireless communication device 104 determines 1108 that inter-frequency cell reselection conditions are met, then the neighbor frequency priority 548 is greater than the serving frequency priority 550 and the neighbor cell signal quality 552 was greater than the high neighbor threshold 556 during the Treselection time 1144. In another configuration, if the wireless communication device 104 determines 1108 that inter-frequency cell reselection conditions are met, then the neighbor frequency priority 548 is not greater than the serving frequency priority 550, the neighbor cell signal quality 552 was greater than a low neighbor threshold 558 and the serving cell signal quality 554 was less than the low serving threshold 560 during the Treselection time 1144. The wireless communication device 104 may then perform 1110 inter-frequency cell reselection.

Upon performing 1110 inter-frequency cell reselection to the neighbor cell 106, the wireless communication device 104 may start 1112 neighbor cell 106 acquisition. During neighbor cell 106 acquisition, the wireless communication device 104 may acquire 1114 System Information Blocks (SIBs). The wireless communication device 104 may also acquire 1116 one or more Multicast Control Channels (MCCHs) 322. The wireless communication device 104 may further acquire 1118 Multicast Channel Scheduling Information (MSI). Upon completing neighbor cell 106 acquisition, the wireless communication device 104 may start 1120 to receive the Multicast Traffic Channel (MTCH) 324. At this point, the wireless communication device 104 knows how to receive the Multicast Traffic Channel (MTCH) 324 (e.g., knows how to decode the Multicast Traffic Channel (MTCH) 324). Therefore, the wireless communication device 104 may receive 1122 the Multicast Traffic Channel (MTCH) 324, which may include media (e.g., streaming audio/video).

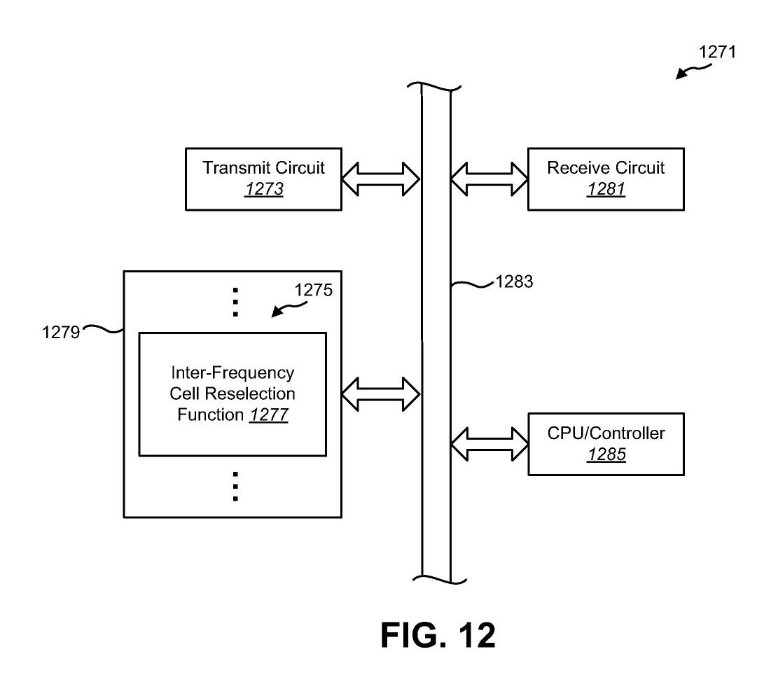

FIG. 12 shows part of a hardware implementation of a wireless communication device 1271 for executing the schemes or processes as described above. The wireless communication device 1271 comprises circuitry as described below. In this specification and the appended claims, it should be clear that the term “circuitry” is construed as a structural term and not as a functional term. For example, circuitry can be an aggregate of circuit components, such as a multiplicity of integrated circuit components, in the form of processing and/or memory cells, units, blocks and the like, such as shown and described in FIG. 12.

The wireless communication device 1271 includes a central data bus 1283 linking several circuits together. The circuits include a CPU (central processing unit) or a controller 1285, a receive circuit 1281, a transmit circuit 1273, and a memory unit 1279.

The receive circuit 1281 and the transmit circuit 1273 can be connected to an RF (radio frequency) circuit (which is not shown in the drawing). The receive circuit 1281 processes and buffers received signals before sending the signals out to the data bus 1283. On the other hand, the transmit circuit 1273 processes and buffers the data from the data bus 1283 before sending the data out of the wireless communication device 1271. The CPU/controller 1285 performs the function of data management of the data bus 1283 and furthers the function of general data processing, including executing the instructional contents of the memory unit 1279.

The memory unit 1279 includes a set of modules and/or instructions generally signified by the reference numeral 1275. In this embodiment, the modules/instructions include, among other things, an inter-frequency cell reselection function 1277, which carries out the schemes and processes as described above. The function 1277 includes computer instructions or code for executing the process steps as shown and described in FIGS. 6-10. Specific instructions particular to an entity can be selectively implemented in the function 1277.

In this embodiment, the memory unit 1279 is a RAM (random access memory) circuit. The exemplary functions, such as the function 1277, include one or more software routines, modules and/or data sets. The memory unit 1279 can be tied to another memory circuit (not shown), which can be either volatile or nonvolatile. As an alternative, the memory unit 1279 can be made of other circuit types, such as an EEPROM (electrically erasable programmable read-only memory), an EPROM (electrical programmable read-only memory), a ROM (read-only memory), an ASIC (application specific integrated circuit), a magnetic disk, an optical disk, and others well known in the art.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

No claim element is to be construed under the provisions of 35 U.S.C. §112, sixth paragraph, unless the element is expressly recited using the phrase “means for” or, in the case of a method claim, the element is recited using the phrase “step for.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 6-10, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods and apparatus described herein without departing from the scope of the claims.

What is claimed is:

1. A wireless communication device, comprising:
means for camping on a serving cell;
means for discovering an evolved multimedia broadcast multicast service provided by a neighbor cell;
means for measuring inter-frequency parameters of the neighbor cell;
means for determining whether to perform an inter-frequency cell reselection based on one or more inter-frequency cell reselection factors; and
means for performing an inter-frequency cell reselection to the neighbor cell.

2. The wireless communication device of claim 1, wherein determining whether to perform an inter-frequency cell reselection is independent of a speed of the wireless communication device.

3. The wireless communication device of claim 1, wherein the inter-frequency parameters comprise at least one of a reference signal received quality measurement and a reference signal received power measurement.

4. The wireless communication device of claim 1, wherein the means for determining whether to perform an inter-frequency cell reselection comprise means for determining whether the wireless communication device has camped on the serving cell for a blocking period, and wherein the blocking period is set to a value less than one second.

5. The wireless communication device of claim 1, wherein an inter-frequency cell reselection factor comprises using a reduced Treselection time based on whether a user chooses the evolved multimedia broadcast multicast service.

6. The wireless communication device of claim 1, wherein an inter-frequency cell reselection factor comprises using a reduced Treselection time based on a scaling factor irrespective of a speed of the wireless communication device.

7. The wireless communication device of claim 1, wherein an inter-frequency cell reselection factor comprises using a reduced Treselection time based on an eMBMS scaling factor.

8. The wireless communication device of claim 1, wherein an inter-frequency cell reselection factor comprises using a reduced Treselection time based on an eMBMS scaling factor and a speed-dependent scaling factor.

9. The wireless communication device of claim 1, wherein the means for determining whether to perform an inter-frequency cell reselection comprise:
means for determining a Treselection time based on an inter-frequency cell reselection factor; and
means for determining whether a neighbor frequency priority is greater than a serving frequency priority.

10. The wireless communication device of claim 9, wherein the neighbor frequency priority is greater than the serving frequency priority, and further comprising means for determining whether a neighbor cell signal quality is greater than a high neighbor threshold for the Treselection time.

11. The wireless communication device of claim 9, wherein the neighbor frequency priority is not greater than the serving frequency priority, and wherein the wireless communication device further comprises:
means for determining whether a neighbor cell signal quality is greater than a low neighbor threshold for the Treselection time; and
means for determining whether a serving cell signal quality is less than a low serving threshold for the Treselection time.

12. The wireless communication device of claim 1, wherein a low serving threshold based on a reference signal received quality measurement is signaled to the wireless communication device, and wherein a neighbor cell signal quality, a serving cell signal quality, a high neighbor threshold and a low neighbor threshold are also based on the reference signal received quality measurement.

13. The wireless communication device of claim 1, wherein a low serving threshold based on a reference signal received quality measurement is not signaled to the wireless communication device, and wherein the low serving threshold, a neighbor cell signal quality, a serving cell signal quality, a high neighbor threshold and a low neighbor threshold are based on a reference signal received power measurement.

14. An apparatus, comprising:
circuitry configured to camp on a serving cell, to discover an evolved multimedia broadcast multicast service provided by a neighbor cell, to measure inter-frequency parameters of the neighbor cell, to determine whether to perform an inter-frequency cell reselection based on one or more inter-frequency cell reselection factors, and to perform an inter-frequency cell reselection to the neighbor cell.

15. The apparatus of claim 14, wherein determining whether to perform an inter-frequency cell reselection is independent of a speed of the apparatus.

16. The apparatus of claim 14, wherein the inter-frequency parameters comprise at least one of a reference signal received quality measurement and a reference signal received power measurement.

17. The apparatus of claim 14, wherein the circuitry configured to determine whether to perform an inter-frequency cell reselection comprises circuitry configured to determine whether the apparatus has camped on the serving cell for a blocking period, and wherein the blocking period is set to a value less than one second.

18. The apparatus of claim 14, wherein an inter-frequency cell reselection factor comprises using a reduced Treselection time based on whether a user chooses the evolved multimedia broadcast multicast service.

19. The apparatus of claim 14, wherein an inter-frequency cell reselection factor comprises using a reduced Treselection time based on a scaling factor irrespective of a speed of the apparatus.

20. The apparatus of claim 14, wherein an inter-frequency cell reselection factor comprises using a reduced Treselection time based on an eMBMS scaling factor.

21. The apparatus of claim 14, wherein an inter-frequency cell reselection factor comprises using a reduced Treselection time based on an eMBMS scaling factor and a speed-dependent scaling factor.

22. The apparatus of claim 14, wherein the circuitry configured to determine whether to perform an inter-frequency cell reselection comprises:
circuitry configured to determine a Treselection time based on an inter-frequency cell reselection factor, and to determine whether a neighbor frequency priority is greater than a serving frequency priority.

23. The apparatus of claim 22, wherein the neighbor frequency priority is greater than the serving frequency priority, and further comprising circuitry configured to determine whether a neighbor cell signal quality is greater than a high neighbor threshold for the Treselection time.

24. The apparatus of claim 22, wherein the neighbor frequency priority is not greater than the serving frequency priority, and wherein the apparatus further comprises:
circuitry configured to determine whether a neighbor cell signal quality is greater than a low neighbor threshold for the Treselection time, and to determine whether a serving cell signal quality is less than a low serving threshold for the Treselection time.

25. The apparatus of claim 14, wherein a low serving threshold based on a reference signal received quality measurement is signaled to the apparatus, and wherein a neighbor cell signal quality, a serving cell signal quality, a high neighbor threshold and a low neighbor threshold are also based on the reference signal received quality measurement.

26. The apparatus of claim 14, wherein a low serving threshold based on a reference signal received quality measurement is not signaled to the apparatus, and wherein the low serving threshold, a neighbor cell signal quality, a serving cell signal quality, a high neighbor threshold and a low neighbor threshold are based on a reference signal received power measurement.

27. A method operable by a wireless communication device, comprising:
camping on a serving cell;
discovering an evolved multimedia broadcast multicast service provided by a neighbor cell;
measuring inter-frequency parameters of the neighbor cell;
determining whether to perform an inter-frequency cell reselection based on one or more inter-frequency cell reselection factors; and
performing an inter-frequency cell reselection to the neighbor cell.

28. The method of claim 27, wherein determining whether to perform an inter-frequency cell reselection is independent of a speed of the wireless communication device.

29. The method of claim 27, wherein the inter-frequency parameters comprise at least one of a reference signal received quality measurement and a reference signal received power measurement.

30. The method of claim 27, wherein determining whether to perform an inter-frequency cell reselection comprises determining whether the wireless communication device has camped on the serving cell for a blocking period, and wherein the blocking period is set to a value less than one second.

31. The method of claim 27, wherein an inter-frequency cell reselection factor comprises using a reduced Treselection time based on whether a user chooses the evolved multimedia broadcast multicast service.

32. The method of claim 27, wherein an inter-frequency cell reselection factor comprises using a reduced Treselection time based on a scaling factor irrespective of a speed of the wireless communication device.

33. The method of claim 27, wherein an inter-frequency cell reselection factor comprises using a reduced Treselection time based on an eMBMS scaling factor.

34. The method of claim 27, wherein an inter-frequency cell reselection factor comprises using a reduced Treselection time based on an eMBMS scaling factor and a speed-dependent scaling factor.

35. The method of claim 27, wherein determining whether to perform an inter-frequency cell reselection comprises:
determining a Treselection time based on an inter-frequency cell reselection factor; and
determining whether a neighbor frequency priority is greater than a serving frequency priority.

36. The method of claim 35, wherein the neighbor frequency priority is greater than the serving frequency priority, and further comprising determining whether a neighbor cell signal quality is greater than a high neighbor threshold for the Treselection time.

37. The method of claim 35, wherein the neighbor frequency priority is not greater than the serving frequency priority, and wherein the method further comprises:
determining whether a neighbor cell signal quality is greater than a low neighbor threshold for the Treselection time; and
determining whether a serving cell signal quality is less than a low serving threshold for the Treselection time.

38. The method of claim 27, wherein a low serving threshold based on a reference signal received quality measurement is signaled to the wireless communication device, and wherein a neighbor cell signal quality, a serving cell signal quality, a high neighbor threshold and a low neighbor threshold are also based on the reference signal received quality measurement.

39. The method of claim 27, wherein a low serving threshold based on a reference signal received quality measurement is not signaled to the wireless communication device, and wherein the low serving threshold, a neighbor cell signal quality, a serving cell signal quality, a high neighbor threshold and a low neighbor threshold are based on a reference signal received power measurement.

40. A computer-program product, the computer-program product comprising a non-transitory computer-readable medium having instructions thereon, the instructions comprising:
code for causing a wireless communication device to camp on a serving cell;
code for causing the wireless communication device to discover an evolved multimedia broadcast multicast service provided by a neighbor cell;
code for causing the wireless communication device to measure inter-frequency parameters of the neighbor cell;
code for causing the wireless communication device to determine whether to perform an inter-frequency cell reselection based on one or more inter-frequency cell reselection factors; and
code for causing the wireless communication device to perform an inter-frequency cell reselection to the neighbor cell.

41. The computer-program product of claim 40, wherein determining whether to perform an inter-frequency cell reselection is independent of a speed of the wireless communication device.

42. The computer-program product of claim 40, wherein the inter-frequency parameters comprise at least one of a reference signal received quality measurement and a reference signal received power measurement.

43. The computer-program product of claim 40, wherein the code for causing the wireless communication device to determine whether to perform an inter-frequency cell reselection comprises code for causing the wireless communication device to determine whether the wireless communication device has camped on the serving cell for a blocking period, and wherein the blocking period is set to a value less than one second.

44. The computer-program product of claim 40, wherein an inter-frequency cell reselection factor comprises using a reduced Treselection time based on whether a user chooses the evolved multimedia broadcast multicast service.

45. The computer-program product of claim 40, wherein an inter-frequency cell reselection factor comprises using a reduced Treselection time based on a scaling factor irrespective of a speed of the wireless communication device.

46. The computer-program product of claim 40, wherein an inter-frequency cell reselection factor comprises using a reduced Treselection time based on an eMBMS scaling factor.

47. The computer-program product of claim 40, wherein an inter-frequency cell reselection factor comprises using a reduced Treselection time based on an eMBMS scaling factor and a speed-dependent scaling factor.

48. The computer-program product of claim 40, wherein the code for causing the wireless communication device to determine whether to perform an inter-frequency cell reselection comprises:
code for causing the wireless communication device to determine a Treselection time based on an inter-frequency cell reselection factor; and
code for causing the wireless communication device to determine whether a neighbor frequency priority is greater than a serving frequency priority.

49. The computer-program product of claim 48, wherein the neighbor frequency priority is greater than the serving frequency priority, and further comprising code for causing the wireless communication device to determine whether a neighbor cell signal quality is greater than a high neighbor threshold for the Treselection time.

50. The computer-program product of claim 48, wherein the neighbor frequency priority is not greater than the serving frequency priority, and wherein the computer-program product further comprises:
code for causing the wireless communication device to determine whether a neighbor cell signal quality is greater than a low neighbor threshold for the Treselection time; and
code for causing the wireless communication device to determine whether a serving cell signal quality is less than a low serving threshold for the Treselection time.

51. The computer-program product of claim 40, wherein a low serving threshold based on a reference signal received quality measurement is signaled to the wireless communication device, and wherein a neighbor cell signal quality, a serving cell signal quality, a high neighbor threshold and a low neighbor threshold are also based on the reference signal received quality measurement.

52. The computer-program product of claim 40, wherein a low serving threshold based on a reference signal received quality measurement is not signaled to the wireless communication device, and wherein the low serving threshold, a neighbor cell signal quality, a serving cell signal quality, a high neighbor threshold and a low neighbor threshold are based on a reference signal received power measurement.
